(19) United States
(12) Patent Application Publication
(10) Pub. No.: US 2009/0250230 A1
(43) Pub. Date: Oct. 8, 2009

(54) Fire protection

(76) Inventor: Tomas Kreutz, Lyckeby (SE)

Correspondence Address: Steven S. Payne, PO Box 65024, Washington, DC, 20035, US

(21) Appl. No.: 11/578,270

(22) PCT Filed: May 31, 2005
(86) PCT No.: PCT/SE05/00815

§ 371 Date: Mar. 27, 2009

(30) Foreign Application Priority Data
Jun. 3, 2004 (SE) 0401416-3

(51) Int. Cl. A62C 3/00; A62C 37/00

(52) U.S. Cl. 169/56; 169/54

(57) ABSTRACT

The present invention concerns a local and active fire protection means at a system for cable entries, pipe penetrations etc. Said system may comprise a frame (1) and a number of modules (2) adaptable to different pipes, cables etc. A sprinkler head (7) either connected to an existing sprinkler system (14) or a pressurised reservoir (10) is received in a module (2) inside the frame (1) together with a conduit (6) connected to the existing sprinkler head (7) or the pressurised reservoir (10). In one example the frame (1) including the sprinkler head (7) is received in a wall (11) separating two compartments (12, 13). The sprinkler head (7) connected to the existing sprinkler system (14) may give a water mist (15) at the frame (1) in one of the compartments (12).

### TECHNICAL FIELD

The present invention concerns a system for cable entries, pipe penetrations etc. More specifically the invention concerns fire protection for such a system.

### PRIOR ART

There are today a number of different systems for receiving cables, pipes etc. going through a wall, roof, floor etc. indifferent kinds of buildings or vessels. The expressions “building” and “vessel” should be construed broadly. Thus, “building” may be a warehouse, a production plant, a cabinet, a container, a technical shelter etc. “Vessel” includes all kinds of ships.

Said systems for receiving cables, pipes etc. normally comprise a frame to be received in the wall etc. and having an inner space to receive the pipes, cables etc. Inside the frame a number of modules made of an elastic material are placed to receive separate cables and/or pipes. Furthermore, some kind of compression unit is normally furnished to give a tight sealing of the cables and/or pipes.

In case of fire there is a potential risk that the fire crosses from one side of a wall etc. to the other side via the parts receiving the cables, pipes etc. and/or via the cables, pipes etc. Systems for cable entries, pipe penetrations etc. are often furnished with a passive fire protection, i.e. its main object is to stop or delay the spread of the fire. The fire protection is normally in form of one or more layers of insulation, which may be based on glass, mineral, ceramic etc. placed on one or both sides of the frame. The frames themselves do normally also have some inherent fire protections. Furthermore, layers of heat expandable material may be furnished in addition to the insulation or as an alternative.

### SUMMARY OF THE INVENTION

As cable entries, pipe penetration etc. are possible places where a fire may spread from one compartment to another compartment etc., it is important to as effectively as possible stop fires at the cable entries etc. Thus, an active fire protection at the systems for cable entries, pipe penetrations etc. is important to enhance the fire security. A sprinkler system is an active fire protection system, i.e. its main object is to stop a fire before it has spread. By arranging a sprinkler-system or parts of such a system locally at cable entries etc. it is guaranteed that an active fire protection is acting locally. If existing sprinkler systems are used without adaptation, (i.e. just the sprinkler system of the building and no sprinkler heads at the frame) the fire protection may have an insufficient local effect.

By using sprinkler heads placed locally at the frame the need of insulation or heat expandable material is obviated.

One object of the present invention is thus to arrange an active fire protection at the system for receiving cable entries, pipe penetrations etc.

According to one aspect of the present application this is achieved in that an existing sprinkler system is used. In vessels and in many buildings where the system for cable entries, pipe penetrations etc. is to be received there already exist a sprinkler system intended for the whole vessel or building. According to the present invention a sprinkler head connected to the existing sprinkler system is placed in or adjacent the system for cable entries, pipe penetrations etc. Normally existing types of sprinkler heads are used without any special adaptation. The conduit of the sprinkler system leading to the local sprinkler head is normally received in a module inside the frame of the system for cable entries, pipe penetrations etc.

Normally a number of detectors are included in a sprinkler system. The detectors may be of many different types, reacting on heat, smoke, gas, flames etc. Often a detecting device is placed in each sprinkler head and triggers the sprinkling locally when a fire or risk of fire is detected. The trigger may have the form of a part melting and breaking at a certain temperature to open the conduit to the sprinkler head. Said triggering part will block the conduit in its normal state. However, the detectors may also be placed at a distance from the sprinkler heads, in which case a signal is given to open the suitable sprinkler heads based on information from the detectors. The exact form of the detectors and triggers is of no importance for the present invention.

In a further aspect of the present application a local sprinkler system is arranged at the system for receiving cable entries, pipe penetrations etc. itself, having a reservoir of water or other fire extinguishant. Thus, in such a case the sprinkler system is self-supporting.

Further objects and advantages will be obvious to a person skilled in the art when reading the detailed description below of at present preferred embodiments.

### BRIEF DESCRIPTION OF THE DRAWINGS

The invention will be described more detailed below by way of example and with reference to the enclosed drawings. In the drawings:

FIG. 1 is a perspective view of one example of a system for cable entries, pipe penetrations etc., furnished with sprinklers in accordance with the present invention;

FIG. 2 is a sketch of one example of a sprinkler head for a sprinkler system according to the present invention;

FIG. 3 shows one example of the inside of a sprinkler head;

FIG. 4 shows an alternative embodiment of a sprinkler system according to the present invention; and

FIG. 5 schematically shows one example of the present invention placed in a building, vessel etc.

### DETAILED DESCRIPTION OF PREFERRED EMBODIMENTS

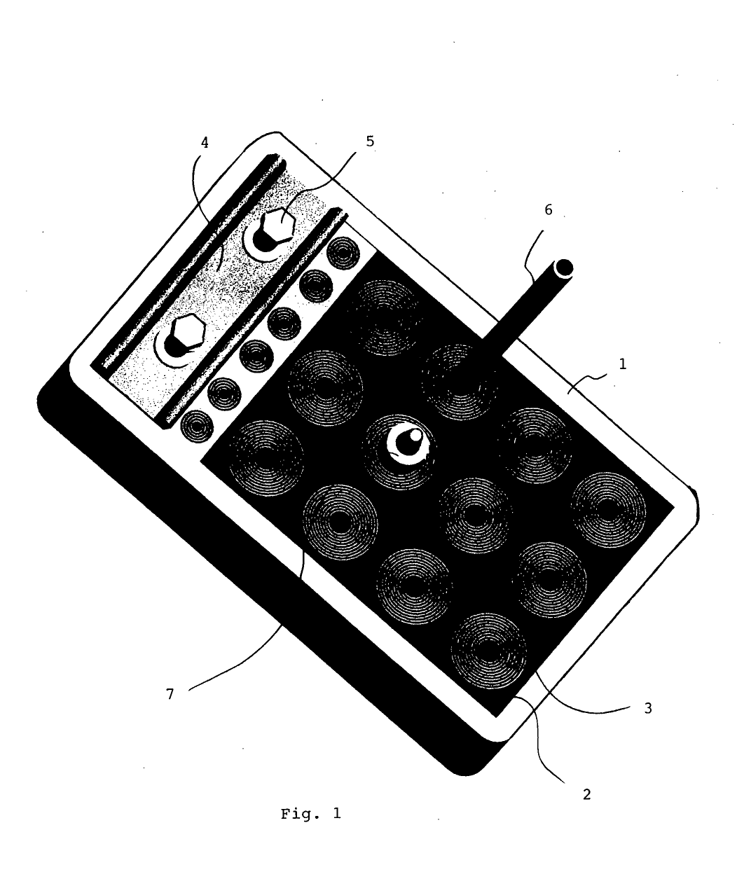

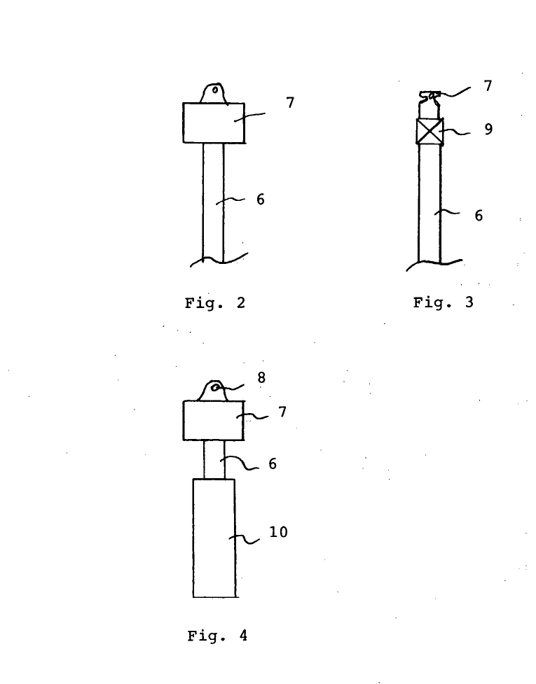

In FIG. 1 one example of a type of systems for cable entries, pipe penetrations etc. is shown. This system is only shown as an example and a person skilled in the art realises that the present invention may be used with many different types of systems.

The system for receiving cable entries, pipe penetrations etc. comprises a frame l, which is to receive a number of modules 2. In the centre 3 of each module 2 an opening, adapted to the size of a pipe, cable etc. is to be formed. The adaptation of the size of the opening is done by peeling of a suitable amount of sheets from the centre 3. Furthermore, the shown system comprises a compression unit 4 having screws 5 to adjust the compression. However, as the exact form of the different modules 2 and the compression unit 4 is of no importance for the present invention it will not be described further here.

As a simplification and to facilitate interpretation none of the cables and/or pipes normally received in the frame is shown in the enclosed Figs. A person skilled in the art realises that in use a number of cables and/or pipes are normally received in the frame.

In at least one of the modules 2 a conduit 6 for a sprinkler head 7 is received. The sprinkler head 7 normally comprises at least one nozzle 8 and one detector 9. The detector 9 is to let water through to the sprinkler nozzle 8 when and if it detects a fire or a possible fire.

The nozzle 8 has normally openings in several directions to spread the water or other fire extinguishant in all directions in a mist form. Instead of several openings the nozzle may be furnished with other means to form the water mist, as is well known by a person skilled in the art. The water or other extinguishant of the conduit 6 is under a pressure in the conduit 6. Thus, when the conduit 6 is opened water or other means is immediately expelled from the nozzle 8.

The detector 9 often includes a trigger, i.e. a device, which is to open the passage of the conduit 6 leading to the sprinkler head 7. In one embodiment the trigger of the detector 9 is a part that breaks at a certain level of heat and opens the conduit 6 to the sprinkler head 7. In other embodiments the trigger is a separate part activated by the detector 9 reacting on excessive heat, smoke, flames, gases etc. In some embodiments there are no local detectors, in which case detectors of the existing sprinkler system, by means of a control system, activate the triggers. Thus, in such cases the sprinkler head 7 comprises merely a trigger instead of the detector 9. The trigger may have the form of a valve placed in the conduit 6.

The conduit 6 is received in a module 2 with the sprinkler head 7 on one side of the module 2. In the example of FIG. 1 the conduit for the shown sprinkler head 7 is placed on the opposite side of the frame 1. Likewise the shown conduit 6 leads to a sprinkler head on the opposite side of the frame 1. Thus, the sprinkler head 7 on one side of the frame 1 is normally connected to the sprinkler system laced on the other side of the frame 1, for convenience in conduit routing. In other embodiments there is one sprinkler head 7 on each side of the frame 1, connected to one and the same conduit 6. Normally the sprinkler head 7 abuts the module 2, but in other embodiments the sprinkler head 7 is placed at a distance from the module 2.

Often there is at least one sprinkler head 7 on each side of the frame 1. However, if the risk of fire is predominately concentrated to one side there may be one or more sprinkler heads 7 only on that side of the frame 1.

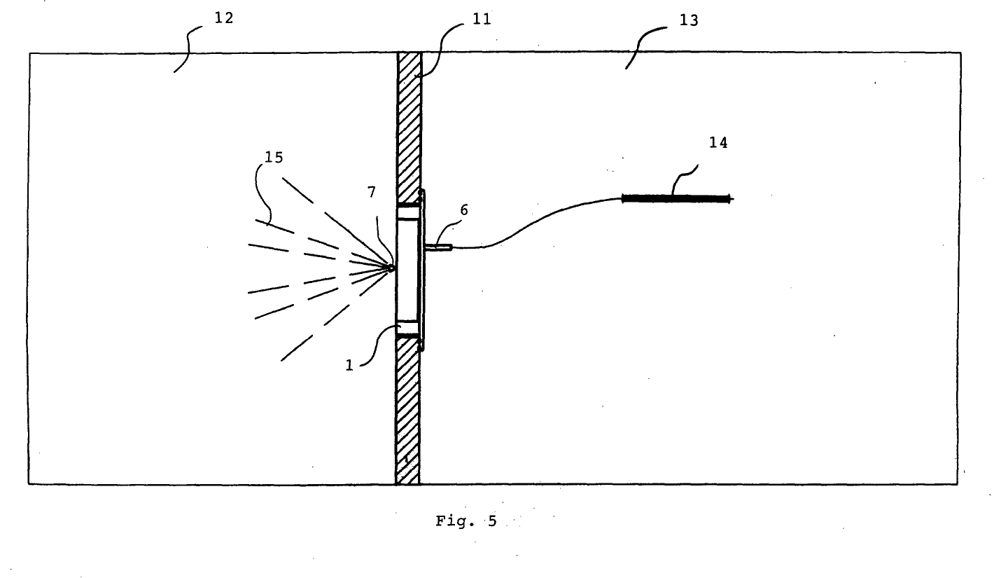

The conduit 6 is to be connected to an existing sprinkler system of the vessel, building etc. in which the frame 1 is received. In the example of FIG. 5 the frame 1 containing the conduit 6 and a sprinkler head 7 is received in a wall 11. The wall 11 separates two compartments 12, 13. One of said compartments 13 have an existing sprinkler system 14 (indicated as a conduit), to which the sprinkler head 7 of the frame 1 is connected by means of the conduit 6. Thus, in the shown example the sprinkler head 7 giving a water mist 15 on one side of the wall 11 is connected to the existing sprinkler system 14 on the other side of the wall 11.

As indicated above the sprinkler head 7 or heads 7 arranged at the frame 1 may be activated by means of local detectors 9 or by other detectors of the total sprinkler system.

In other embodiments the sprinkler head or heads are given other positions. Thus, in other embodiments the sprinkler head 7 and conduit 6 are received in the compression unit 4, in the frame 1 or in a special module (not shown). If the sprinkler conduit 6 is received in the frame 1, it may be received in a local extension of the frame.

In one embodiment the sprinkler system of the system for receiving cable entries, pipe penetrations etc. is self-supporting. It is self-supporting in the sense that it is not connected to an existing sprinkler system of a building or a vessel. The self-supporting sprinkler system includes a pressurised reservoir 10. The pressurised reservoir 10 includes enough water or other fire extinguishant to form a suitable water mist when needed. Often there is a short conduit 6 leading from the reservoir 10 to the sprinkler head 7. In which case the short conduit 6 is received in a module 2 inside the frame 1. In other instances the sprinkler head 7 is received directly on the reservoir 10. In which case the reservoir 10 is received in a module 2 inside the frame 1. For self-supporting systems the sprinkler head 7 almost always contains a detector 9 also acting as a trigger. In some embodiments though detector or detectors at a distance from the sprinkler head 7 are used. Said distant detectors may be detectors of an existing sprinkler system.

In some cases the sprinkler system is the only straightforward fire protection of the system for receiving cable entries, pipe penetrations etc. In other cases the sprinkler system is combined with a passive fire protection in form of heat-expandable material or the like.

1-14. (canceled)

15. A system for cable entries, pipe penetrations, comprising at least one sprinkler head of a sprinkler system being placed in the system for receiving cable entries, pipe penetrations.

16. The system of claim 15, wherein a conduit connected to the sprinkler head is received in the system for cable entries, pipe penetrations.

17. The system of claim 16, wherein the sprinkler head comprises at least one nozzle, means to open the conduit connected to the sprinkler head and/or at least one detector and that the nozzle spreads a water mist in all directions.

18. The system of claim 17, wherein the detector contains the means to open the conduit, in that a part of the detector normally closing the conduit breaks or melts and/or that the detector is reacting on heat, smoke, flames or gas.

19. The system of claim 17, wherein a passive fire protection is combined with the sprinkler system of the system for receiving cable entries, pipe penetrations.

20. The system of claim 19, wherein the passive fire protection is a layer of heat expanding material.

21. The system of claim 16, wherein the system comprises a frame, modules to receive separate cables or pipes and a possible compression unit, which modules and compression unit are received inside the frame.

22. The system of claim 21, wherein the sprinkler head is placed abutting the module receiving the conduit.

23. The system of claim 21, wherein the sprinkler head is placed at a distance from the module receiving the conduit.

24. The system of claim 16, wherein the conduit is connected to an existing sprinkler system of a building, vessel etc. in which the system is mounted.

25. The system of claim 24, wherein detectors of the existing sprinkler system is used and that the conduit is opened by means of a control system of the existing sprinkler system.

26. The system of claim 16, wherein the sprinkler system is self-supporting comprising a pressurised reservoir.

27. The system of claim 26, wherein the pressurised reservoir is received in a module inside a frame of the system.

28. The system of claim 26, wherein the pressurised reservoir and the sprinkler head are placed on opposite sides of a module inside a frame of the system and that a conduit leading from the reservoir to the sprinkler head is received in the module.
